(19) United States
(12) Patent Application Publication
(10) Pub. No.: US 2023/0139137 A1
(43) Pub. Date: May 4, 2023

(54) TOKENIZED CARBON CREDIT TRADING PLATFORM

(71) Applicant: Carbon2o2 LLC, Naples, FL (US)

(72) Inventor: Harry Slack, Naples, FL (US)

(73) Assignee: Carbon2o2 LLC, Naples, FL (US)

(21) Appl. No.: 17/973,113

(22) Filed: Oct. 25, 2022

Related U.S. Application Data
(60) Provisional application No. 63/274,258, filed on Nov. 1, 2021.

(51) Int. Cl. G06Q 40/04; G06Q 30/00

(52) U.S. Cl. CPC G06Q 40/04; G06Q 30/018

(57) ABSTRACT

The present invention is directed to a distributed ledger-based platform for buying and selling carbon NFTs representing carbon credits. The carbon NFTs each represent 1 ton of carbon emissions and are able to be traded in real-time. In one embodiment, the platform produces at least one non-fungible token (NFT) representing carbon credits, wherein the at least one NFT includes a carbon credit issuance serial number, a name of the associated project, a location (e.g., geospatial coordinates) of the project, a project start date, a project end date, a project duration, a company associated with the project, at least one image of the project, and/or an expiration date for the carbon credit.

### CROSS-REFERENCE TO RELATED APPLICATIONS

This application is related to and claims priority from the following US patent applications. This application claims priority to and the benefit of U.S. Provisional Patent Application No. 63/274,258, filed Nov. 1, 2021, which is incorporated herein by reference in its entirety.

### BACKGROUND OF THE INVENTION

### 1. Field of the Invention

The present invention relates to distributed ledger-based platforms for creating and trading tokens, and more specifically to platforms for creating and trading tokenized carbon credits and non-fungible tokens (NFTs).

### 2. Description of the Prior Art

It is generally known in the prior art to provide platforms for minting and trading carbon credits.

Prior art patent documents include the following:

US Patent Publication No. 2021/0314143 for Encryption For blockchain cryptocurrency transactions and uses in conjunction with carbon credits by inventor Conner, filed Apr. 15, 2019 and published Oct. 7, 2021, discloses encryption for blockchain cryptocurrency. In some embodiments, the encryption is implemented using one-time pad techniques. The key for the one-time pad may be derived from a true random sequence. Data messages are encrypted and decrypted using the one-time pad key. Also disclosed is an Internet-of-Things system that comprises an Internet-connected device that has a sensor that generates a stream measurement data. This stream of measurement data may be the basis for the true random sequence used for deriving the one-time pad key. Also disclosed is a method of trading carbon credits using a cryptocurrency market platform. The blockchain platform may use a proof-of-elapsed time (PoET) protocol for energy-use savings during mining.

US Patent Publication No. 2021/0295431 for Asset usage rights token for connected ecosystems by inventors Vo et al., filed Mar. 18, 2021 and published Sep. 23, 2021, discloses an Asset Usage Rights Token for connected ecosystems. Asset usage rights represent the right to use something of value under specified contractual terms such as a section of road, a parking space, a right of way, airspace, a charging station, etc. These mobility and transportation asset usage rights backing AURTs guarantee a certain dollar amount of resource use, rather than a certain quantity of use which help facilitate the monetization of public goods like streets, parking space etc.

WIPO Patent Publication No. 2019/182183 for Compensation system for reducing carbon emissions by using cryptocurrency, filed Mar. 26, 2018 and published Sep. 26, 2019, discloses a compensation system for reducing carbon emissions by using cryptocurrency, comprising: a node computer of a cryptocurrency recipient for connecting to a blockchain network; a cryptocurrency-issuing device for connecting to the blockchain network; and a carbon emission reduction certification device of the cryptocurrency recipient for connecting to the cryptocurrency-issuing device. In the system, the carbon emission reduction certification device transmits carbon emission reduction data to certify the result of carbon emission reduction of the cryptocurrency recipient to the cryptocurrency-issuing device, and the cryptocurrency-issuing device receives and verifies the carbon emission reduction data, and then newly issues cryptocurrency proportional to the amount of carbon emission reduction, and pays the newly issued cryptocurrency to the cryptocurrency recipient. The compensation system for reducing carbon emissions by using cryptocurrency according to the invention makes it possible to quickly obtain the circulation amount of the cryptocurrency by paying the newly issued cryptocurrency as compensation to a person who achieves the carbon emission reduction, thereby allowing the cryptocurrency to be used stably as currency, and also being capable of more effectively promoting carbon emission reductions.

US Patent Publication No. 2021/0174446 for Offtake-based asset backed securities and co2 removal models by inventor Chichilnisky, filed Dec. 4, 2020 and published Jun. 10, 2021, discloses methods, systems and apparatuses, including computer programs encoded on computer storage media, to manage transactions relating to assets, such as carbon dioxide (“CO2”) offtake agreements, via a distributed ledger system. The platform may allow for authorized users to create large bundles of CO2 offtake agreements, transfer offtake bundles to other users in exchange for payment, create and issue securities backed by offtake bundles and/or manage various payments and contractual obligations relating to the same.

US Patent Publication No. 2021/0151202 for Automated CO2 offsetting in real-time by inventors Jabbar et al., filed Nov. 20, 2020 and published May 20, 2021, discloses aspects that can be embodied in methods that include CO2 offsetting in short term intervals that range from daily, hourly, and all the way down to offsetting by the second. These offsetting methods take place through renewable energy installations in single or multiple locations globally. These installations can be owned and operated by individuals or deployed in various geographies by leasing companies, decentralized utilities, or similar set-ups. The carbon offsets generated, issued, sold, and retired through these methods include live production data from a variety of IoT devices, such as, but not limited to, smart meters, converters, inverters, and monitoring systems, as well as payment and ERP systems. Another innovative aspect of the invention includes methods for software application plug-ins that interface with one or several embodiments of the system. These methods enable the automated offsetting in real-time of particular CO2 emission behaviors of consumers that relate to domains such as, but not limited to, (i) building automation, (ii) transport and mobility (air, land and sea), (iii) retail, and (iv) banking and payment services. Furthermore, another innovative aspect of the invention includes the methods for importing pre-issued carbon offset credits from third-party carbon registries, and issuing, blending and selling these credits though the automation and real-time features of various embodiments of the method. The carbon offsets, or other digital energy attributions, created through the methods in the invention can be automatically retired on purchase, and can therefore not be double issued, or double spent.

U.S. Pat. No. 10,983,958 for Sustainable energy tracking system utilizing blockchain technology and Merkle tree hashing structure by inventors Miller et al., filed Nov. 25, 2020 and issued Apr. 20, 2021, discloses an apparatus and associated methods relating to generating energy blocks on a blockchain corresponding to generation, transmission, and consumption of predetermined quanta of energy represented by corresponding records in an associated Merkle trie. In an illustrative example, individual energy data records may be hashed. Each hash may be stored in a leaf node of a Merkle trie. The individual energy data records may be aggregated to correspond to represent a predetermined quantum of energy. The individual energy data records may include energy generation records. The energy blocks may be associated with scheduling, delivery, and consumption data for the energy quantum. Various embodiments may advantageously provide secure, verifiable, and immutable tracking and processing of energy generation, transmission, and consumption of physical energy quanta across one or more distributed energy networks.

US Patent Publication No. 2021/0117981 for Methods, Device, Block Chain Node, Computer-Readable Media And System For Carbon Recording And Trading Based On Block Chain by inventors Tian et al., filed Jan. 10, 2019 and published Apr. 22, 2021, discloses methods, devices, block chain nodes, computer readable media and a system for carbon recording and trading based on a block chain. A method for carbon recording and trading based on a block chain includes: obtaining data related to carbon behaviors of a plurality of objects; converting the data related to the carbon behaviors of the plurality of objects to corresponding carbon data of the plurality of objects, respectively; transmitting the carbon data to a block chain platform for storage; performing, based on the carbon data, a carbon trading between two objects in the plurality of objects or one object in the plurality of objects and a third party object not belonging to the plurality of objects; and distributing the carbon trading to the block chain platform as a block chain transaction.

US Patent Publication No. 2020/0027096 for System, business and technical methods, and article of manufacture for utilizing internet of things technology in energy management systems designed to automate the process of generating and/or monetizing carbon credits by inventor Cooner, filed Nov. 5, 2018 and published Jan. 23, 2020, discloses carbon credits conforming to ISO 14064-66 standards. Once generated, carbon credits can be stored in a distributed, Cloud-based ledger. The ledger entries can serve as a registry for carbon credits as well as the data source for an Internet-enabled trading system or financial exchange that allows the carbon credits to be sold and bought as part of the same system. The distributed ledger can provide records that combine the details of the carbon credits' origin, transaction history, and financial instructions associated with trading of the carbon credits via a distributed ledger system.

US Patent Publication No. 2019/0311443 for Methods, systems, apparatuses and devices for facilitating provisioning of audit data related to energy consumption, water consumption, water quality, greenhouse gas emissions, and air emissions using blockchain by inventor Blades, filed Apr. 5, 2019 and published Oct. 10, 2019, discloses a method of facilitating provisioning of audit data related to energy consumption, water consumption, water quality, greenhouse gas emissions, and air emissions using blockchain, in accordance with some embodiments. Accordingly, the method may include receiving, using a communication device, a sensory data from at least one measuring device. Further, the method may include analyzing, using a processing device, the sensory data. Further, the method may include generating, using the processing device, the audit data based on the analyzing. Further, the audit data may include at least one of an energy usage data, a carbon emission data, a water usage data, an air emissions data, and a water quality data. Further, the method may include storing, using a storage device, the audit data on blockchain. Further, the audit data may be used for at least one of monitoring purposes, reporting purposes, and analytical purposes.

U.S. Pat. No. 9,818,109 for User generated autonomous digital token system by inventor Loh, filed Aug. 13, 2013 and issued Nov. 14, 2017, discloses a digital token system and methods to provide user generated digital tokens includes receiving from a plurality of users authorization to create one or more unique tokens without approval from a central authority, wherein each user who created the unique token (“creator”) is the only user authorized to increase quantity of the same token-type; and rendering the quantity of each token type visible to recipients of the token.

### SUMMARY OF THE INVENTION

The present invention relates to distributed ledger-based platforms for creating and trading tokens, and more specifically to platforms for creating and trading tokenized carbon credits.

It is an object of this invention to provide a platform that allows for the trading of carbon credits, so as to encourage reduction of the carbon footprint of individuals and/or companies.

In one embodiment, the present invention is directed to a system for trading carbon NFTs, wherein transfers of carbon NFTs are validated on a distributed ledger, and wherein the system is operable to facilitate the transfer of the carbon NFTs to a burn wallet, wherein the burn wallet is a wallet without an associated access key.

In another embodiment, the present invention is directed to a system for trading carbon credits, wherein carbon reductions and/or carbon offset measures are validated as non-fungible tokens (NFTs) on a distributed ledger, and wherein each entry is associated with meta data including at least one geospatial coordinate, at least one start date, and a person and/or company associated with the carbon reductions and/or the carbon offset measures.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates a flow chart for a system for generating and trading carbon NFTs according to one embodiment of the present invention.

FIG. 2 illustrates a flow chart providing the life cycle of a carbon NFT according to one embodiment of the present invention.

FIG. 3 illustrates a user dashboard for a carbon NFT trade platform according to one embodiment of the present invention.

FIG. 4 illustrates a user profile page for a carbon NFT trade platform according to one embodiment of the present invention.

FIG. 5 illustrates a company profile page for a carbon NFT trade platform according to one embodiment of the present invention.

FIG. 6 illustrates a project list page for a carbon NFT trade platform according to one embodiment of the present invention.

FIG. 7 illustrates a new project creation page for a carbon NFT trade platform according to one embodiment of the present invention.

FIG. 8 illustrates a carbon token list page for a carbon NFT trade platform according to one embodiment of the present invention.

FIG. 9 illustrates a market page for a carbon NFT trade platform according to one embodiment of the present invention.

FIG. 10 illustrates a purchased carbon NFT list page for a carbon NFT trade platform according to one embodiment of the present invention.

FIG. 11 is a schematic diagram of a system of the present invention.

### DETAILED DESCRIPTION

The present invention relates to distributed ledger-based platforms for creating and trading tokens, and more specifically to platforms for creating and trading tokenized carbon credits.

In one embodiment, the present invention is directed to a system for trading carbon NFTs, wherein transfers of carbon NFTs are validated on a distributed ledger, and wherein the system is operable to facilitate the transfer of the carbon NFTs to a burn wallet, wherein the burn wallet is a wallet without an associated access key.

In another embodiment, the present invention is directed to a system for trading carbon credits, wherein carbon reductions and/or carbon offset measures are validated as non-fungible tokens (NFTs) on a distributed ledger, and wherein each entry is associated with meta data including at least one geospatial coordinate, at least one start date, and a person and/or company associated with the carbon reductions and/or the carbon offset measures.

None of the prior art discloses the specific data associated with NFTs corresponding to each carbon credit on a distributed ledger in combination with providing for trading of carbon offsets of any size with NFTs, with the carbon offsets being tied only to projects where carbon emissions have already been captured, destroyed, recycled, and offset. Furthermore, none of the prior art includes a platform with a three-step verification process for the tokenization of carbon credits, to confirm an exact quantity of carbon NFTs generated.

Ronald Coase argued in his seminal 1960 article “The Problem of Social Cost” that social harms such as pollution were not properly accounted for in the market because there did not exist a market mechanism for internalizing the costs from the pollution to the polluter. In response, Coase proposed his namesake Coase Theorem, which states that where trade in a negative externality is possible and there are minimal transaction costs, a Pareto efficient outcome will result. While Coase was not writing specifically about climate change, climate change perhaps represents the most relevant application of the Coase Theorem today. The mechanism of using carbon credits to represent allowed amounts of carbon emissions for each company. The idea was originally that the amount of carbon credits allocated to each company would gradually be reduced by year and therefore emissions would be forced to go down.

Previous initiatives to create carbon credit markets, such as Kyoto Protocol have largely been unsuccessful, for a variety of reasons. For one, the initiative suffered problems due to inconsistency in carbon markets (therefore impacting the ability to make any real coordinated effort), issues with tracking the amount of greenhouse gas emissions actually produced, and refusals of governments to actually reduce the number of available carbon credits to an extent that would make a significant impact. The Kyoto Protocol has since largely been succeeded by the 2016 Paris Agreement, Article 6 of which again promotes carbon markets as a way to reduce greenhouse gas emissions.

Similarly, carbon offset programs implemented on smaller scales, such as California's carbon offset program, have questionable value in actually fighting climate change due to incentives to generate carbon credits that do not correspond to a real offset in carbon emissions and flaws in calculating the amount of carbon that is actually offset. Variability in tree species in storing carbon, for instance, lead to flaws in accounting the actual amount of carbon emissions offset by these trees, and carbon credits are sometimes double counted. Additionally, carbon credits are often forward looking, such as carbon credits tied to carbon sequestration by trees which have just been planted. Natural disasters, as well as interference by man, cause damage to or destruction of these trees and therefore render the forward-looking carbon credits associated with trees inaccurate. Furthermore, in addition to legitimate mistakes, fraud has been an issue in the carbon credit market in the past, as companies have misrepresented their projects or emissions in order to get around regulations.

In order to accommodate a new wave of interest in carbon markets, the present invention addresses the issues that plagued the Kyoto Protocol and has previously caused inaccurate accounting of carbon offsets. Specifically, the use of distributed ledger platforms in the present invention helps to solve many of the issues that plagued previous carbon markets. For example, distributed ledger-based platforms are able to incorporate rules decreasing the number of carbon NFTs created annually such that government bodies are unable to simply alter the rules to accommodate the interests of larger polluters. Furthermore, distributed ledger-based platforms allow for expiration dates to be placed on each carbon credit, reducing the ability of companies to simply aggregate NFTs and splurge at a later time. Expiration dates are not practically able to be implemented without the use of such a distributed ledger platform, as the regulatory oversight required to check for expiration is impractical for even the most developed countries. Distributed ledger-based platforms also allow for a speed and volume of transactions that is not achievable with other existing cap and trade platforms. Finally, the present invention utilizes a distributed ledger-based platform to provide an immutable record of a specific carbon offset which has been measured and verified, including details which allow for independent verification of the carbon offset, such as metadata including a geographic location, a start date, and a contact associated with the carbon offset. Furthermore, the present invention provides ease of availability of one or more carbon credits logged on a distributed ledger, helping to prevent fraud.

Carbon offsets according to the present invention include any measurable and verifiable reduction of carbon in the environment, such as the reduction in emissions due to plugging so-called “orphan wells,” which are abandoned oil and gas wells that release methane into the environment. The present invention is particularly advantageous over prior art, as proceeds from the sale of carbon NFTs representing carbon offsets provide funding for the implementation of further carbon reduction programs. Additionally, the fractionalization of tonnage of carbon offsets provided by the carbon NFT of the present invention make the purchase of carbon offsets accessible to many more potential purchasers than prior carbon offset trading systems.

Referring now to the drawings in general, the illustrations are for the purpose of describing one or more preferred embodiments of the invention and are not intended to limit the invention thereto.

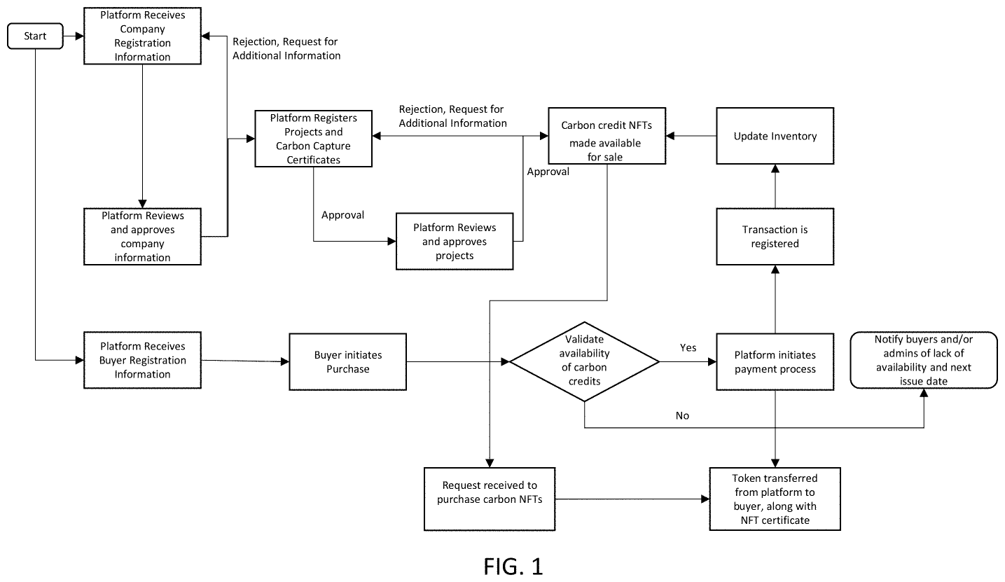

FIG. 1 illustrates a flow chart for a system for generating and trading carbon credit NFTs. In one embodiment, the platform, including a server having a processor and a database, receives registration information from at least one company, validates the registration, and receives registration information for individual carbon offset and/or carbon reduction projects, including information regarding the amount of carbon offset from each project. In one embodiment, the platform calculates a number of total carbon credits corresponding to each project. In one embodiment, a carbon credit corresponds to an exact amount of CO2 reduction, such as 1 ton of CO2 production. In another embodiment, a carbon credit corresponds to exact quantities of greenhouse gas emissions other than CO2, such as methane, nitrous oxide, ozone, water vapor, chlorofluorocarbons (CFCs), hydrofluorocarbons (HFCs), and/or perfluorocarbons. In one embodiment, the number of carbon credit NFTs minted is based on a received selection of a number of carbon credits from the company profile ordering creation of the carbon credit NFTs. In one embodiment of the present invention, one carbon NFT equates to one carbon credit. In one embodiment, for each project uploaded by a company, the platform requires a first validation by the company or a party approved by the company. In one embodiment, the first validation is required to be performed by a third-party evaluator recognized on a whitelist on the platform. In another embodiment, the first validation is allowed to be performed by the company itself. In one embodiment, after receiving the first validation for the project, the platform automatically performs a second validation on the data. In one embodiment, the second validation is performed by an artificial intelligence module associated with the platform. In one embodiment, the artificial intelligence module takes into account at least one image of a site associated with the project, a comparison to prior, similar projects, satellite imagery of the site associated with the project, sensor data, and/or other data. In one embodiment, a third, manual validation is performed by an administrator of the platform. The third manual validation is useful for checking a project, in the event that a particular project has a peculiarity that the platform did not recognize and/or if a particular data point associated with the project falls well outside a norm for the project.

Advantageously, the carbon credit NFTs or NFTs representing other greenhouse gases are operable to be fractionalized. In other words, the present invention provides for trading of fractions of carbon NFTs representing carbon credits. Traditionally, carbon credits have been traded in tonnes, thereby preventing trading of portions of carbon offsets, and preventing individuals or entities which cannot afford whole tonnes from participating in carbon credit markets. The present invention meets the longstanding, unmet need of allowing trading of fractions of tonnes through carbon credit NFTs representing carbon offsets. However, in one embodiment, the minimum amount of carbon represented by each carbon credit NFT is 1 tonne. In one embodiment, after calculating the total number of carbon credits, the platform mints an NFT representing each carbon credit, wherein the tokenized carbon credit is a non-fungible token. In one embodiment, each NFT includes associated metadata, such as the type of project that created the offset associated with the NFT, the location of the project, the certification protocol followed to create this offset, and the external certifier that was used. This information provides for a level of transparency that allows users to have the flexibility to choose the desired amount of carbon they wish to offset for a given project. Additionally, the present invention allows for purchasers to choose to purchase carbon credit NFTs associated with certain projects or certain locations, or to purchase carbon credit NFTs associated with carbon offsets verified by certain entities. Upon minting carbon credit NFTs, a tracked offset is created by the token contract, which aggregates in a platform marketplace in order to record the real world carbon credit on a distributed ledger. Upon retiring a carbon NFT to retire an offset, the carbon NFT is paired with the exact offset project (e.g., transferred to a burn wallet associated with the exact offset project) for immutable record keeping. Secondary tracking is implemented by smart contracts in one embodiment of the present invention, where NFTs in the offset pool are programmed with information on the attributes of emission reduction projects that produced the offsets. Minted carbon credit NFTs are available to be dispersed via exchange sales or strategic reserve volumes.

In another embodiment, the platform also generates a non-fungible token (NFT) corresponding to each carbon credit via a smart contract. One of ordinary skill in the art will understand that each carbon credit NFT minted by the platform does not necessarily correspond to a single carbon credit, but is able to correspond to a plurality of carbon credits associated with a specific offset project or a single carbon credit. In one embodiment, the NFT includes information regarding the project used to generate the carbon credit, including, but not limited to, a carbon credit issuance serial number, a name of the associated project, a location (e.g., geospatial coordinates, which are determined via a Global Positioning System (GPS) in one embodiment) of the project, a project start date, a project end date, a project duration, a company associated with the project, at least one image of the project, and/or an expiration date for the carbon credit. Alternatively, information regarding the project used to generate the carbon credit is encoded as metadata in the relevant carbon credit NFT.

In one embodiment, the platform receives registration information from a company (e.g., at least one username, at least one password, at least one email, at least one phone number, at least one registered agent, at least one registered officer, at least one location, etc.) in order to generate a company profile.

In one embodiment, the platform receives registration information from at least one buyer to generate at least one buyer profile. In one embodiment, buyer registration information includes at least one username, at least one password, at least one associated email, at least one associated social media account (FACEBOOK, INSTAGRAM, TWITTER, LINKEDIN, etc.), at least one phone number, at least one payment method, at least one associated crypto wallet, and/or at least one security trading credential, wherein the at least one security trading credential indicates a certificate to buy and/or sell specific types of assets, such as carbon credits. After buyer registration, the platform is operable to receive at least one request from a user device associated with the at least one buyer profile to buy one or more carbon NFTs. After receiving the at least one buyer request, the platform verifies that the designated one or more carbon NFTs are available. If the NFTs are not available, a message indicating the unavailability is automatically transferred to the buyer profile. In one embodiment, the message includes a time in which tokens from the same project and/or the same company are likely to again become available. If the NFTs are available, the payment process is initiated via a smart contract, automatically transferring fiat currency and/or cryptocurrency from the buyer in exchange for the one or more carbon NFTs. Because the NFTs are stored as hash values on a distributed ledger, transactions of the carbon NFTs are automatically recorded and an inventory of remaining and/or available carbon NFTs is automatically updated.

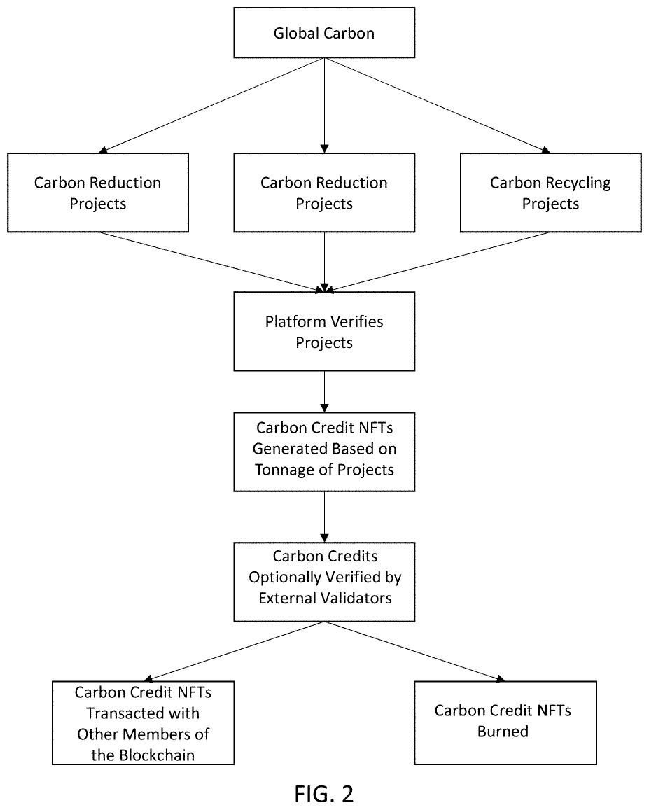

FIG. 2 illustrates a flow chart providing the life cycle of a carbon credit NFT according to one embodiment of the present invention. In one embodiment, the platform is operable to interface with an existing carbon credit validator in order to verify the number of carbon credits for each project. In another embodiment, the platform is operable to receive a number of designated carbon credits for each company profile, without external validation. In yet another embodiment, the platform is operable to interface with one or more sensors, wherein the one or more sensors are able to detect an amount of greenhouse gases produced. In one embodiment, the one or more sensors are able to be associated with a company profile. When the one or more sensors detect that 1 ton of CO2 less than a predetermined amount (i.e., a baseline amount) has been produced over a particular time period, then one carbon NFT is added to a wallet associated with the company profile. In one embodiment, the baseline amount of carbon emissions is based on historical carbon production data associated with the company profile. In another embodiment, the baseline amount is based on a goal amount and/or an expected amount of emissions by the company set on the company profile. In yet another embodiment, the baseline amount is based on an industry standard for the type and/or size of business, and/or a comparison to the actual emissions produced by one or more other companies in the same industry over the same period of time. In another embodiment, the one or more sensors are able to detect when 1 ton of CO2 has been sequestered from the environment, and, in response, one carbon credit NFT is added to a wallet associated with the company profile. Sensors able to be used for the present application include, but are not limited to, flame ionization detectors (FIDs), catalytic gas sensors, semiconductor sensors operable to detect a change in gas concentration, electrochemical sensors operable to detect a change in gas concentration, and/or infrared (IR) sensors (e.g., nondispersive IR sensors). Examples of carbon sensors able to be used in the present application include, but are not limited to, those described in U.S. Pat. Nos. 9,514,493 and 8,504,252, each of which is incorporated herein by reference in its entirety. In yet another embodiment, one or more satellite images (e.g., IR images, visual spectra images, etc.) are used to detect how much carbon is produced by a company over a period of time. In one embodiment, at least one location where the satellite images are taken is automatically selected from at least one location associated with the company profile.

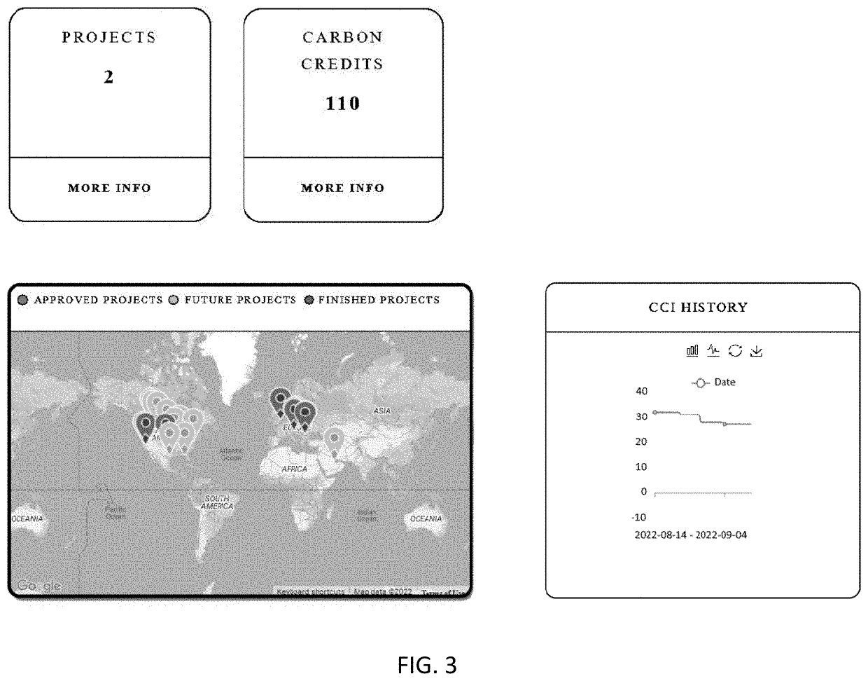

FIG. 3 illustrates a user dashboard for a carbon NFT trade platform according to one embodiment of the present invention. A user profile registered with the carbon NFT trade platform includes a user dashboard page. In one embodiment, the user dashboard page includes a number of projects operated by the user profile and/or a company profile associated with the user profile, a number of projects for which the user profile holds corresponding carbon NFTs, a total number of carbon NFTs held by the user, a number of founder tokens held by the user, and/or an amount of available currency (e.g., native cryptocurrency minted through the platform) for the user profile to purchase additional carbon NFTs.

In one embodiment, the user dashboard page includes at least one map interface. In one embodiment, the at least one map interface includes pins located at various portions of the map, indicating projects operated by the user profile or a company associated with the user profile. In one embodiment, the at least one map interface includes pins located at various portions of the map, indicating projects associated with carbon NFTs purchased by the user profile. In one embodiment, the pins are color coded, with one color indicating completed projects, one color indicating future projects, and one color indicating approved, and potentially ongoing projects. By visualizing where projects are located, a user is better able to understand the global impact of carbon reduction strategies, providing greater satisfaction and greater knowledge for the user. In one embodiment, the at least one map interface is retrieved by the carbon NFT trade platform by at least one external API to a map providing platform (e.g., GOOGLE MAPS, WAYMO, APPLE MAPS, etc.).

In one embodiment, the user dashboard page includes at least one graph showing the number of carbon credit NFTs held by the user profile over time. In one embodiment, the at least one graph shows the total number of carbon NFTs held over time. In another embodiment, the at least one graph shows the per time period (e.g., per day, per week, per month, per year) change in the number of carbon credit NFTs (or carbon credits represented by said NFTs) held by the user profile over time. The at least one graph is able to include a line graph, a bar graph, and/or any other suitable form of graph, and is able to alternate between graph views based on selection received from a user device. In one embodiment, the carbon NFT trade platform receives an input to download a spreadsheet and/or image associated with the at least one graph in order to allow the user to have direct access to the data.

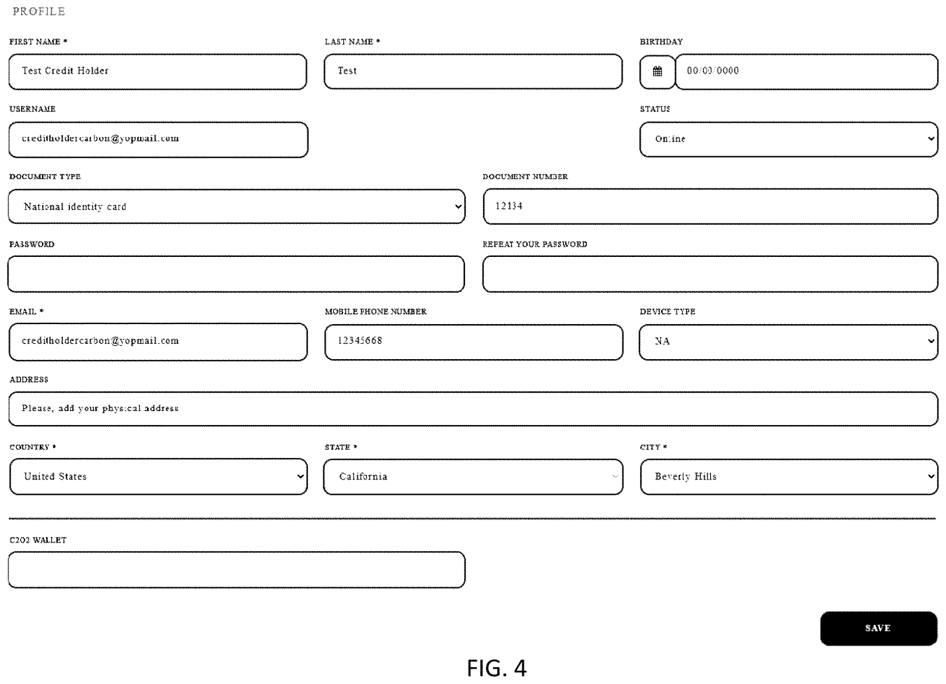

FIG. 4 illustrates a user profile page for a carbon NFT trade platform according to one embodiment of the present invention. A user profile page includes personal information, contact information, and/or financial information regarding the individual operating the user profile page. Examples of personal information include, but are not limited to, a first name, a middle name, a last name, a username, a password, and/or a birthday. Examples of contact information include, but are not limited to, at least one email address, at least one phone number, at least one device type (e.g., IPHONE, MACBOOK, ANDROID phone, etc.) used to access the user profile, and/or an address. Examples of financial information include, but are not limited to, at least one bank account number, at least one credit card number, at least one cryptocurrency wallet, and/or at least one third party financial account (e.g., PAYPAL, VENMO, etc.). In one embodiment, carbon NFTs bought or sold through the carbon NFT trade platform are automatically taken from or added to the at least one cryptocurrency wallet associated with the user profile. In one embodiment, the user profile includes at least one form of identification (e.g., drivers license, national identity card, passport, etc.) used to verify the user's identity.

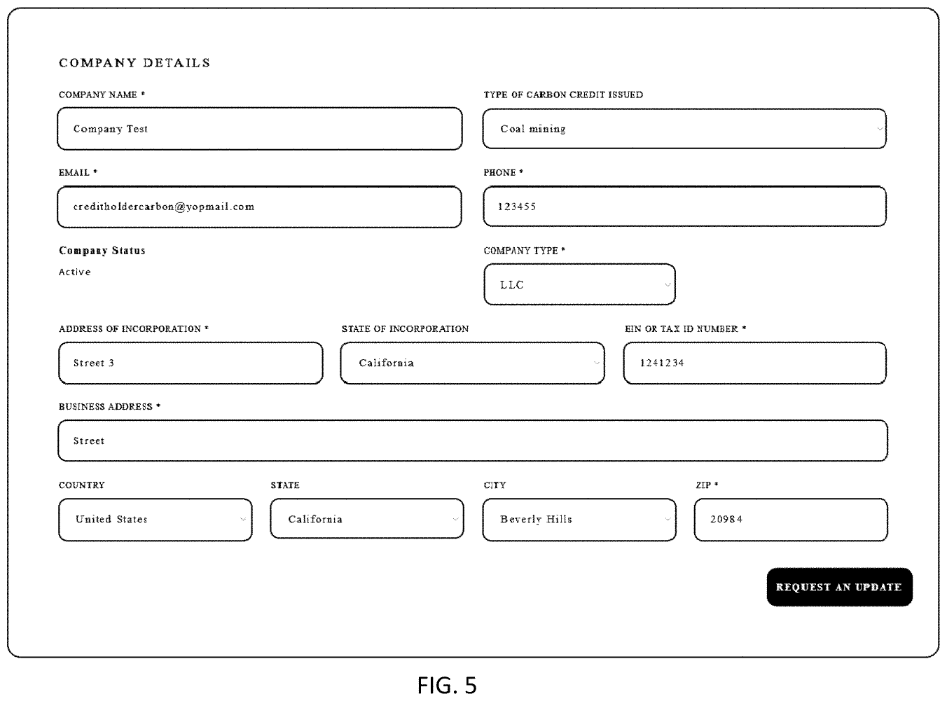

FIG. 5 illustrates a company profile page for a carbon NFT trade platform according to one embodiment of the present invention. In one embodiment, a user profile is associated with at least one company profile. In one embodiment, the at least one company profile includes information such as a company name, one or more types of carbon credits issued to the company (e.g., coal mining carbon credit, oil drilling carbon credit, etc.), contact information for the company (e.g., at least one email address, at least one phone number, etc.), an entity type (e.g., C-corporation, limited liability company, etc.), at least one address associated with the company, a state of incorporation, and/or a tax identification number. In one embodiment, the at least one company profile includes a list of linked user profiles and a role for each of the listed linked user profiles. In one embodiment, editing specific information for the at least one company profile and/or creating new projects for the at least one company profile is limited to only designated roles of listed linked user profiles. In one embodiment, the carbon NFT trade platform receives a selection by the at least one user profile to automatically transfer one or more carbon NFTs held by the at least one user profile to the at least one company profile.

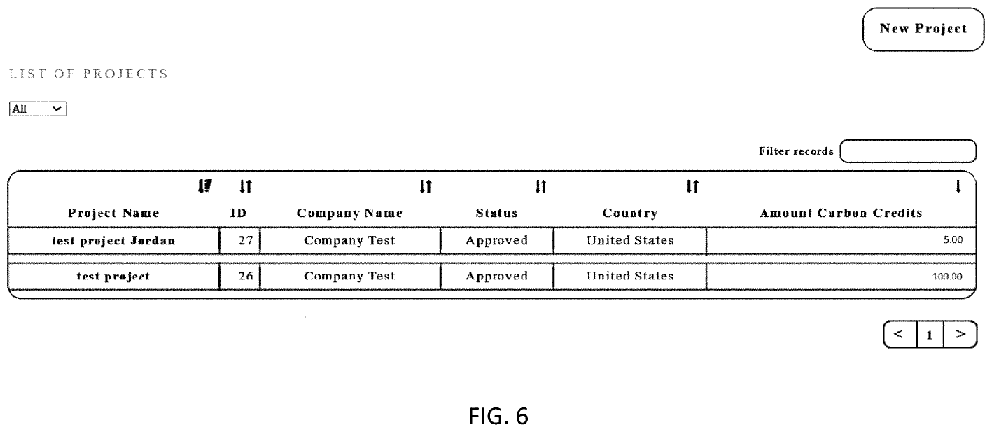

FIG. 6 illustrates a project list page for a carbon NFT trade platform according to one embodiment of the present invention. The project list page allows a user to manage projects more effectively and visualize from which projects the most carbon NFTs are being generated. The project list page includes a list of carbon reduction projects performed or to be performed by the at least one user profile and/or the at least one company profile. In one embodiment, the project list page includes a name of each project, a company associated with each project, a status of each project (e.g., approved by the carbon NFT trade platform, pending, rejected, etc.), one or more countries in which each project is to be performed, and/or an amount of carbon credits generated or to be generated by each project. In one embodiment, the project list page receives a selection of one or more criteria by which to sort the list of projects, including, but not limited to, project name, company name, status, country, and/or amount of carbon credits generated.

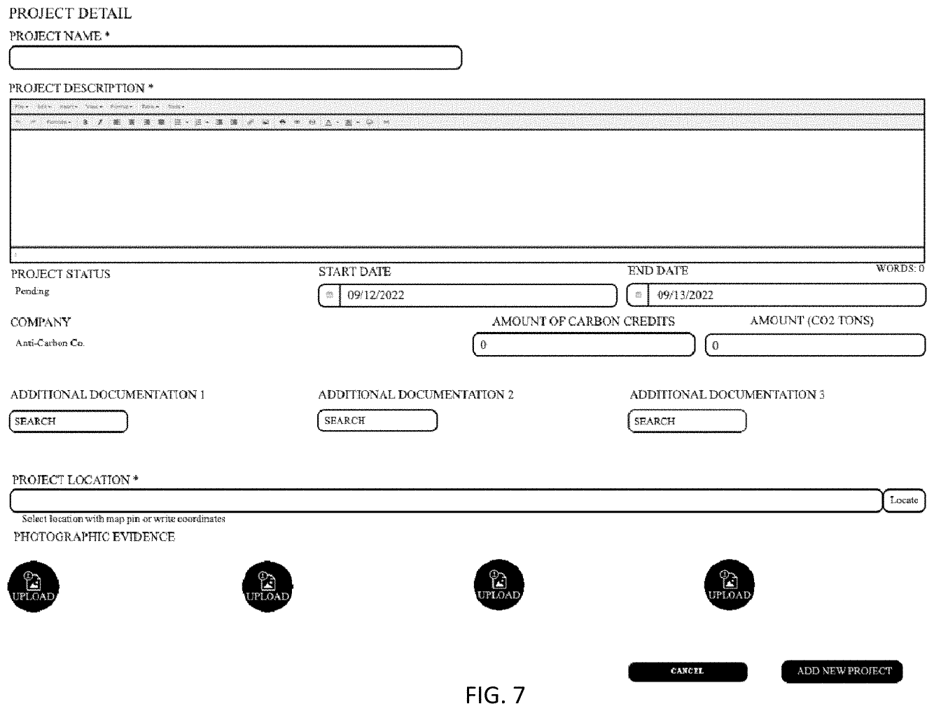

FIG. 7 illustrates a new project creation page for a carbon NFT trade platform according to one embodiment of the present invention. The new project creation page provides an interface by which a user profile is about to generate one or more new projects in order to be provided additional carbon NFTs. In one embodiment, the new project creation page receives inputs of a project name, project description, project status (complete, pending, planned, etc.), a start date, an end date, an associated company or company profile, and/or an amount of carbon credits to be generated or an amount of carbon to be saved. In one embodiment, the new project creation page receives one or more documents associated with the project (e.g., an action plan, photographic evidence of one or more sites associated with the project, certifications associated with the project, etc.). In one embodiment, the new project creation page receives a location associated with the project in the form of text coordinates and/or a pin added to a built-in map interface.

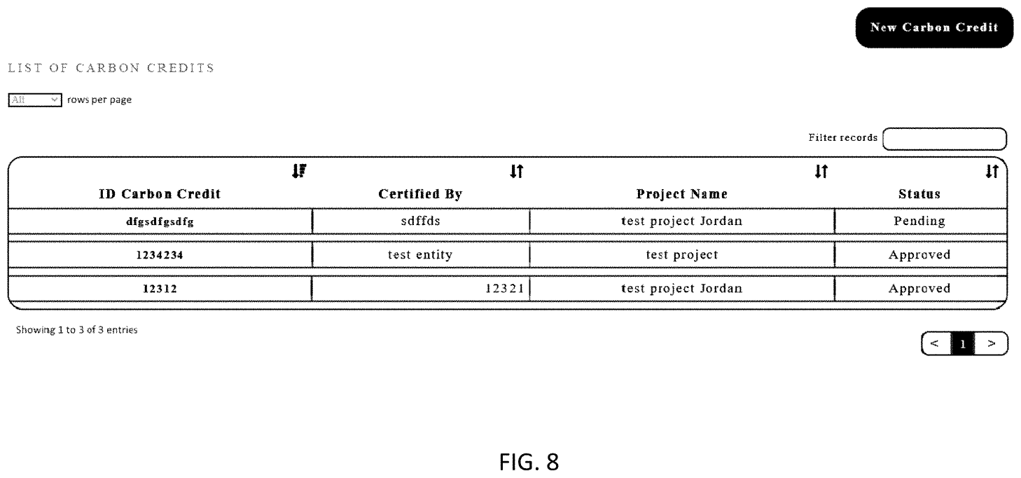

FIG. 8 illustrates a carbon NFT list page for a carbon NFT trade platform according to one embodiment of the present invention. The carbon NFT list page provides an overview of the carbon NFTs held by each user profile. In one embodiment, the carbon NFT list page includes a carbon credit for each carbon NFT or set of carbon NFTs, a certifying entity for each carbon NFT or set of carbon NFTs, a project name by which each carbon NFT or set of carbon NFTs were generated, and/or a status (e.g., pending, approved, etc.) of the project by which each carbon NFT or set of carbon NFTs were generated.

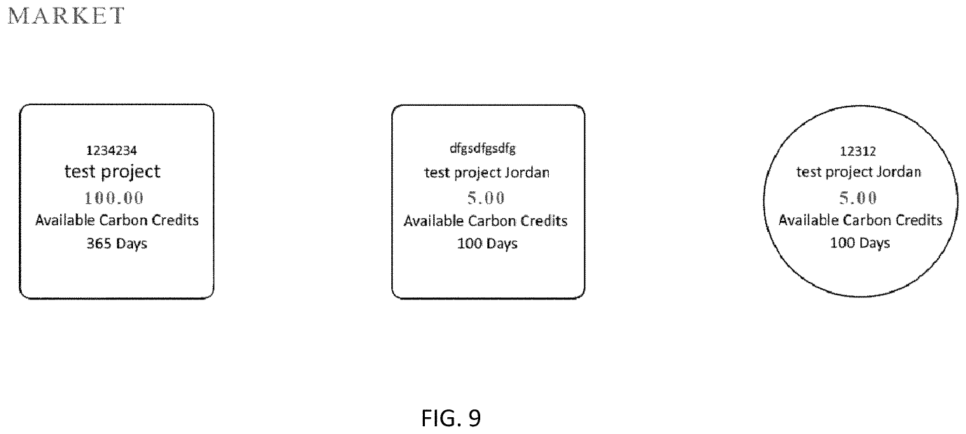

FIG. 9 illustrates a market page for a carbon NFT trade platform according to one embodiment of the present invention. The market page provides an interface with which a user profile is able to purchase new carbon NFTs. In one embodiment, the market page includes a visual representation for each set of carbon NFTs with an identification code for the carbon NFTs, a project name for each carbon NFT, a company name associated with each carbon NFT, a number of carbon NFTs in each set, a status of each set of carbon NFTs (e.g., available carbon NFTs, future planned carbon NFTs, etc.), and/or a time period in which the carbon NFTs are available to be used. In one embodiment, the market page is configured to receive payment information from a user profile and to add one or more sets of carbon NFTs to a purchasing user profile.

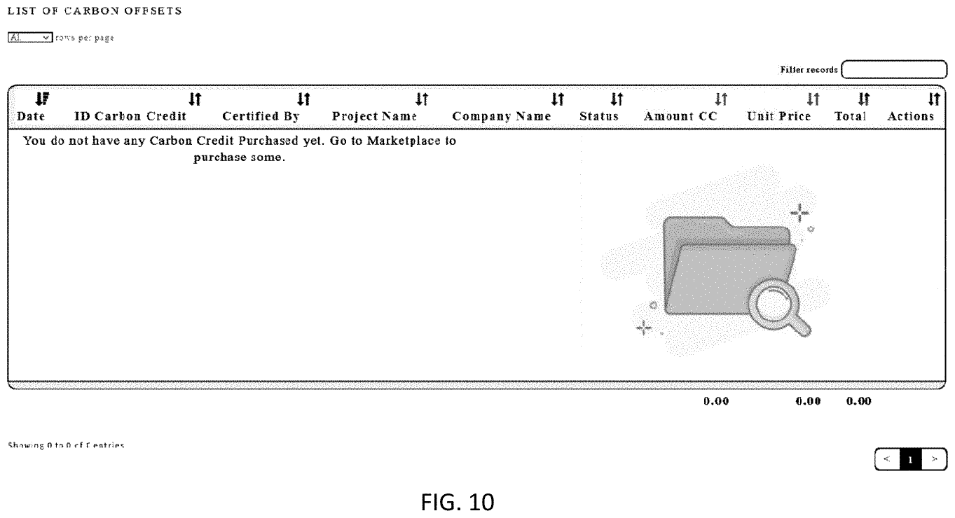

FIG. 10 illustrates a purchased carbon NFT list page for a carbon NFT trade platform according to one embodiment of the present invention. Similar to FIG. 8, FIG. 10 provides a list of carbon NFTs held by each user profile. However, unlike the list provided in FIG. 8, the purchased carbon NFT list page only lists those carbon credit NFTs purchased by the user profile, as opposed to those generated by the user profile or by a company profile associated with the user profile. In one embodiment, each listing in the carbon NFT list page includes a date associated with the carbon NFT (e.g., date purchased, date generated, an expiration date, etc.), an identification code for each carbon NFT, a certifying entity for each carbon NFT, a project name associated with each carbon NFT, a company name associated with each carbon NFT, a status of the project used to generate each carbon NFT, an amount of carbon NFTs in each set of carbon NFTs, and/or a price for which each carbon NFT or set of carbon NFTs were purchased.

One of ordinary skill in the art will understand that the types of projects able to offset and/or abate an amount of carbon sufficient to generate carbon NFTs vary. By way of example and not limitation, projects include carbon sequestration projects, initiatives to reduce annual (or semiannual, monthly, weekly, daily, etc.) carbon emissions, initiatives to reduce carbon emissions produced by products (e.g., initiatives to make more fuel-efficient vehicles), carbon recycling projects, and other projects. In a specific embodiment, carbon NFTs are automatically generated when 1 ton of greenhouse gases are saved as a result of closing abandoned oil and/or gas wells. In one embodiment, the platform automatically “retires” a fixed amount of carbon offsets at the time of the creation of each NFT. By way of example and not of limitation, in one embodiment, if a company saves 250 tons of CO2 with a project, 25 tons (or 10% of the total offsets) are automatically retired and carbon NFTs equivalent to 225 tons of total CO2 are produced. One of ordinary skill in the art will understand that 10% is not intended to be limiting and other percentages, including 1%, 5%, 15%, 20%, 30%, 50%, etc., also are able to be implemented. In another embodiment, no amount of carbon offsets are automatically retired and 250 tons of CO2 will yield exactly 250 carbon NFTs. In another embodiment, projects are ones that cause an amount of pollution and the projects are received by the platform in order for the platform to determine how many carbon NFTs should be burned for the company conducting the project.

Carbon NFTs represented by the tokens of the present invention are verified by recognized international protocols such as International Organization for Standardization (ISO) (e.g., ISO 14064-66, which is incorporated herein by reference in its entirety), Clean Development Mechanism (CDM), European Union Emission Trading System (ETS), and Verified Emission Reductions (VCR) in one embodiment. Additionally, in one embodiment, the carbon offsets represented by the NFTs of the present invention are verified by accredited third-party organizations.

In one embodiment, the platform includes its own repository of platform carbon credit NFTs. In one embodiment, these carbon credits are not linked to an external validator of carbon credits, nor are they generated through validation of a user company's carbon reduction projects. In one embodiment, companies and/or individuals are able to purchase platform carbon credit NFTs on the platform for a fixed amount, which are then able to be transferred to other parties for a price set by the market.

In one embodiment, the platform assigns an expiration date for one or more of the carbon NFTs. After the expiration date, a carbon NFT is automatically transferred to at least one burn wallet. A burn wallet is a wallet without an associated access key, which is therefore unable to be accessed for using the contents of the wallet. Effectively, NFTs transferred to a burn wallet are taken out of the system. In another embodiment, one carbon NFT is automatically transferred to a burn wallet when a company pollutes 1 additional ton of CO2. In one embodiment, pollution of 1 additional ton of CO2 is based on measurement of one or more sensors of CO2 production relative to a baseline amount for a period of time, a self-reported net amount of additional CO2 generated, and/or a quantity of additional CO2 generated by one or more governing entities (e.g., the Environmental Protection Agency (EPA)). In another embodiment, the carbon NFTs do not have expiration dates. In one embodiment, the platform takes into account not only the amount of carbon saved or produced by each individual project (e.g., amount of carbon produced via a factory), but also the amount of carbon produced or saved in transportation and logistics regarding each individual project (e.g., the amount of carbon produced by trucks driving coal to a power plant for burning).

In one embodiment, the platform includes at least one native cryptocurrency, implemented as ETHEREUM Request for Comments 20 (ERC-20) tokens. In one embodiment, at least one native cryptocurrency and/or at least one fiat currency is able to be exchanged in return for one or more of the carbon credit NFTs. In one embodiment, mining undertaken in order to validate transactions on the blockchain generates MATIC tokens. In one embodiment, the NFTs used in the present invention are tokens produced according to the ERC-721 protocol.

In one embodiment, the platform is operable to generate a plurality of different native token types. In one embodiment, a first token type provides dividends for an associated “founder” company each time the token is transferred. In one embodiment, the associated founder company is a company who originally owned the token. In another embodiment, the associated founder company is a third-party company that has invested in the rights to receive dividends in the token, but is not necessarily directly associated with any project that led to the creation of the token. In one embodiment, each time a token of the first token type is transferred, the platform transmits an amount of fiat currency and/or cryptocurrency to a financial account associated with the associated founder company. In one embodiment, the amount of fiat currency is transferred from the buyer of the token, from the seller of the token, and/or from a centralized pool of funds that is linked to neither a financial account of the buyer, nor a financial account of the seller.

Data Stored on a Distributed Ledger

In a preferred embodiment, the platform is operable to store data on a distributed ledger, e.g., a blockchain. Distributed ledger technology refers to an infrastructure of replicated, shared, and synchronized digital data that is decentralized and distributed across a plurality of machines, or nodes. The nodes include but are not limited to a mobile device, a computer, a server, and/or any combination thereof. Data is replicated and synchronized across a network of nodes such that each node has a complete copy of the distributed ledger. The replication and synchronization of data across a distributed set of devices provides increased transparency over traditional data storage systems, as multiple devices have access to the same set of records and/or database. Additionally, the use of distributed ledgers eliminates the need for third party and/or administrative authorities because each of the nodes in the network is operable to receive, validate, and store additional data, thus creating a truly decentralized system. Eliminating the third party and/or administrative authorities saves time and cost. A decentralized database is also more secure than traditional databases, which are stored on a single device and/or server because the decentralized data is replicated and spread out over both physical and digital space to segregated and independent nodes, making it more difficult to attack and/or irreparably tamper with the data. Tampering with the data at one location does not automatically affect the identical data stored at other nodes, thus providing greater data security.

In addition to the decentralized storage of the distributed ledger, which requires a plurality of nodes, the distributed ledger has further advantages in the way that data is received, validated, communicated, and added to the ledger. When new data is added to the distributed ledger, it must be validated by a portion of the nodes (e.g., 51%) involved in maintaining the ledger in a process called consensus. Proof of work, proof of stake, delegated proof of stake, proof of space, proof of capacity, proof of activity, proof of elapsed time, and/or proof of authority consensus are all compatible with the present invention, as are other forms of consensus known in the art. In one embodiment, the present invention uses fault-tolerant consensus systems. Each node in the system is operable to participate in consensus, e.g., by performing at least one calculation, performing at least one function, allocating compute resources, allocating at least one token, and/or storing data. It is necessary for a portion of the nodes in the system (e.g., 51% of the nodes) to participate in consensus in order for new data to be added to the distributed ledger. Advantageously, requiring that the portion of the nodes participate in consensus while all nodes are operable to participate in consensus means that authority to modify the ledger is not allocated to one node or even a group of nodes but rather is equally distributed across all of the nodes in the system. In one embodiment, a node that participates in consensus is rewarded, e.g., with a digital token, in a process called mining.

The blockchain is a commonly used implementation of a distributed ledger and was described in Satoshi Nakamoto's whitepaper Bitcoin: A Peer-to-Peer Electronic Cash System, which was published in October 2008 and which is incorporated herein by reference in its entirety. In the blockchain, additional data is added to the ledger in the form of a block. Each block is linked to its preceding block with a cryptographic hash, which is a one-way mapping function of the data in the preceding block that cannot practically be computed in reverse. In one embodiment, a timestamp is also included in the hash. The computation of the cryptographic hash based on data in a preceding block is a computationally intensive task that could not practically be conducted as a mental process. The use of cryptographic hashes means that each block is sequentially related to the block before it and the block after it, making the chain as a whole immutable. Data in a block in a preferred embodiment cannot be retroactively altered after it is added to the chain because doing so changes the associated hash, which affects all subsequent blocks in the chain and which breaks the mapping of the preceding block. The blockchain is an improvement on existing methods of data storage because it connects blocks of data in an immutable fashion. Additionally, the blockchain is then replicated and synchronized across all nodes in the system, ensuring a distributed ledger. Any attempted changes to the blockchain are propagated across a decentralized network, which increases the responsiveness of the system to detect and eliminate fraudulent behavior compared to non-distributed data storage systems. The blockchain and the distributed ledger solve problems inherent to computer networking technology by providing a secure and decentralized way of storing data that is immutable and has high fault tolerance. The distributed ledger stores digital data and is thus inextricably tied to computer technology. Additional information about the blockchain is included in The Business of Blockchain by William Mougavar published in April 2016, which is incorporated herein by reference in its entirety.

In one embodiment, the data added to the distributed ledger of the present invention include digital signatures. A digital signature links a piece of data (e.g., a block) to a digital identity (e.g., a user account). In one embodiment, the digital signature is created using a cryptographic hash and at least one private key for a user. The content of the piece of data is used to produce a cryptographic hash. The cryptographic hash and the at least one private key are used to create the digital signature using a signature algorithm. The digital signature is only operable to be created using a private key. However, the digital signature is operable to be decoded and/or verified using a public key also corresponding to the user. The separation of public keys and private keys means that external parties can verify a digital signature of a user using a public key but cannot replicate the digital signature since they do not have a private key. Digital signatures are not merely electronic analogs of traditional physical signatures. Physical signatures are easily accessible and easily replicable by hand. In addition, there is no standard algorithm to verify a physical signature except comparing a first signature with a second signature from the same person via visual inspection, which is not always possible. In one embodiment, the digital signatures are created using the data that is being linked to the digital identity whereas physical signatures are only related to the identity of the signer and are agnostic of what is being signed. Furthermore, digital signatures are transformed into a cryptographic hash using a private key, which is a proof of identity of which there is no physical or pre-electronic analog. Digital signatures, and cryptographic hashes in general, are of sufficient data size and complexity to not be understood by human mental work, let alone verified through the use of keys and corresponding algorithms by human mental work. Therefore, creating, decoding, and/or verifying digital signatures with the human mind is highly impractical.

Public, private, consortium, and hybrid blockchains are compatible with the present invention. In one embodiment, the blockchain system used by the present invention includes sidechains wherein the sidechains run parallel to a primary chain. Implementations of distributed ledger and/or blockchain technology including, but not limited to, BITCOIN, ETHEREUM, POLYGON, HASHGRAPH, BINANCE, FLOW, TRON, TEZOS, COSMOS, and/or RIPPLE are compatible with the present invention. In one embodiment, the platform includes at least one acyclic graph ledger (e.g., at least one tangle and/or at least one hashgraph). In one embodiment, the platform includes at least one quantum computing ledger.

In one embodiment, the present invention further includes the use of at least one smart contract, wherein a smart contract includes a set of automatically executable steps and/or instructions that are dependent on agreed-upon terms. The smart contract includes information including, but not limited to, at least one contracting party, at least one contract address, contract data, and/or at least one contract term. In one embodiment, the at least one smart contract is deployed on a blockchain such that the at least one smart contract is also stored on a distributed node infrastructure. In one embodiment, the terms of the at least one smart contract are dependent on changes to the blockchain. For example, a provision of the at least one smart contract executes when a new block is added to the blockchain that meets the terms of the at least one smart contract. The smart contract is preferably executed automatically when the new block is added to the blockchain. In one embodiment, a first smart contract is operable to invoke a second smart contract when executed. A smart contract is operable to capture and store state information about the current state of the blockchain and/or the distributed ledger at any point in time. Advantageously, a smart contract is more transparent than traditional coded contracts because it is stored on a distributed ledger. Additionally, all executions of the smart contract are immutably stored and accessible on the distributed ledger, which is an improvement over non-distributed, stateless coded contracts. In one embodiment, the state information is also stored on a distributed ledger.

Cryptocurrency Transactions

Distributed ledger technology further enables the use of cryptocurrencies. A cryptocurrency is a digital asset wherein ownership records and transaction records of a unit of cryptocurrency (typically a token) are stored in a digital ledger using cryptography. Use of centralized cryptocurrencies and decentralized cryptocurrencies are both compatible with the present invention. Centralized cryptocurrencies are minted prior to issuance and/or are issued by a single body. Records of a decentralized cryptocurrency are stored on a distributed ledger (e.g., a blockchain), and any node participating in the distributed ledger is operable to mint the decentralized cryptocurrency. The distributed ledger thus serves as a public record of financial transactions. Cryptocurrencies are typically fungible in that each token of a given cryptocurrency is interchangeable. The present invention is operable to facilitate transactions of at least one cryptocurrency, including, but not limited to, BITCOIN, LITECOIN, RIPPLE, NXT, DASH, STELLAR, BINANCE COIN, and/or ETHEREUM. In one embodiment, the present invention is operable to facilitate transactions of stablecoins, NEO Enhancement Protocol (NEP) tokens, and/or BINANCE Chain Evolution Proposal (BEP) tokens. In one embodiment, the present invention is operable to support tokens created using the ETHEREUM Request for Comment (ERC) standards as described by the Ethereum Improvement Proposals (EIP). For example, the present invention is operable to support ERC-20-compatible tokens, which are created using the EIP-20: ERC-20 Token Standard, published by Vogelsteller, et al., on Nov. 19, 2015, which is incorporated herein by reference in its entirety.

A cryptocurrency wallet stores keys for cryptocurrency transactions. As cryptocurrency is a virtual currency, the ability to access and transfer cryptocurrency must be protected through physical and/or virtual means such that such actions are only operable to be performed by the rightful owner and/or parties with permission. In one embodiment, a cryptocurrency wallet stores a private key and a public key. In another embodiment, the cryptocurrency wallet is operable to create the private key and/or the public key, encrypt data, and/or sign data (e.g., with a digital signature). In one embodiment, the private key is generated via a first cryptographic algorithm wherein the input to the first cryptographic algorithm is random. Alternatively, the input to the first cryptographic algorithm is non-random. In one embodiment, the public key is generated from the private key using a second cryptographic algorithm. In one embodiment, the first cryptographic algorithm and the second cryptographic algorithm are the same. The private key is only accessible to the owner of the cryptocurrency wallet, while the public key is accessible to the owner of the cryptocurrency wallet as well as a receiving party receiving cryptocurrency from the owner of the cryptocurrency wallet. Deterministic and non-deterministic cryptocurrency wallets are compatible with the present invention.

As a non-limiting example, a cryptocurrency transaction between a first party and a second party involves the first party using a private key to sign a transaction wherein the transaction includes data on a first cryptocurrency wallet belonging to the first party, the amount of the transaction, and a second cryptocurrency wallet belonging to the second party. In one embodiment, the second cryptocurrency wallet is identified by a public key. The transaction is then populated to a distributed network wherein a proportion (e.g., 51%) of the nodes of the distributed network verify the transaction. Verifying the transaction includes verifying that the private key corresponds to the first cryptocurrency wallet and that the amount of the transaction is available in the first cryptocurrency wallet. The nodes then record the transaction on the distributed ledger, e.g., by adding a block to a blockchain. Fulfilling the cryptocurrency transaction is a computationally intensive process due to key cryptography and the consensus necessary for adding data to the distributed ledger that could not practically be performed in the human mind. In one embodiment, a node is operable to verify a block of transactions rather than a single transaction.

Desktop wallets, mobile wallets, hardware wallets, and web wallets are compatible with the present invention. A software wallet (e.g., a desktop wallet, a mobile wallet, a web wallet) stores private and/or public keys in software. A hardware wallet stores and isolates private and/or public keys in a physical unit, e.g., a universal serial bus (USB) flash drive. The hardware wallet is not connected to the internet or any form of wireless communication, thus the data stored on the hardware wallet is not accessible unless the hardware wallet is connected to an external device with network connection, e.g., a computer. In one embodiment, the data on the hardware wallet is not operable to be transferred out of the hardware wallet. In one embodiment, the hardware wallet includes further data security measures, e.g., a password requirement and/or a biometric identifier requirement. In one embodiment, the present invention is operable to integrate a third-party cryptocurrency wallet. Alternatively, the present invention is operable to integrate a payments platform that is compatible with cryptocurrency, including, but not limited to, VENMO, PAYPAL, COINBASE, and/or payments platforms associated with financial institutions. Common wallets used for Ethereum tokens include METAMASK wallets, which are able to be integrated into the present invention to pay for transactions on the Ethereum blockchain.

Tokenization

In one embodiment, the platform is operable to tokenize assets. A token is a piece of data that is stored on the distributed digital ledger and that can be used to represent a physical and/or a digital asset, e.g., in a transaction, in an inventory. The token is not the asset itself; however, possession and transfer of the token are stored on the distributed digital ledger, thus creating an immutable record of ownership. In one embodiment, the token includes cryptographic hashes of asset data, wherein the asset data is related to the asset. In one embodiment, the asset data is a chain of data blocks. For example, the asset is a work of digital art, and the asset data includes data about the work such as information about an artist, a subject matter, a file type, color data, etc. The corresponding token includes a cryptographic hash of the asset data, which describes the work. Alternative mappings of the asset data to the token are also compatible with the present invention. In one embodiment, the token is a non-fungible token (NFT). A first non-fungible token is not directly interchangeable with a second non-fungible token; rather, the value of the first token and the second token are determined in terms of a fungible unit (e.g., a currency). In one embodiment, the platform is operable to support ETHEREUM standards for tokenization, including, but not limited to, EIP-721: ERC-721 Non-Fungible Token Standard by Entriken, et al., which was published Jan. 24, 2018 and which is incorporated herein by reference in its entirety. In one embodiment, the platform is operable to create fractional NFTs (f-NFTs), wherein each f-NFT represents a portion of the asset. Ownership of an f-NFT corresponds to partial ownership of the asset.

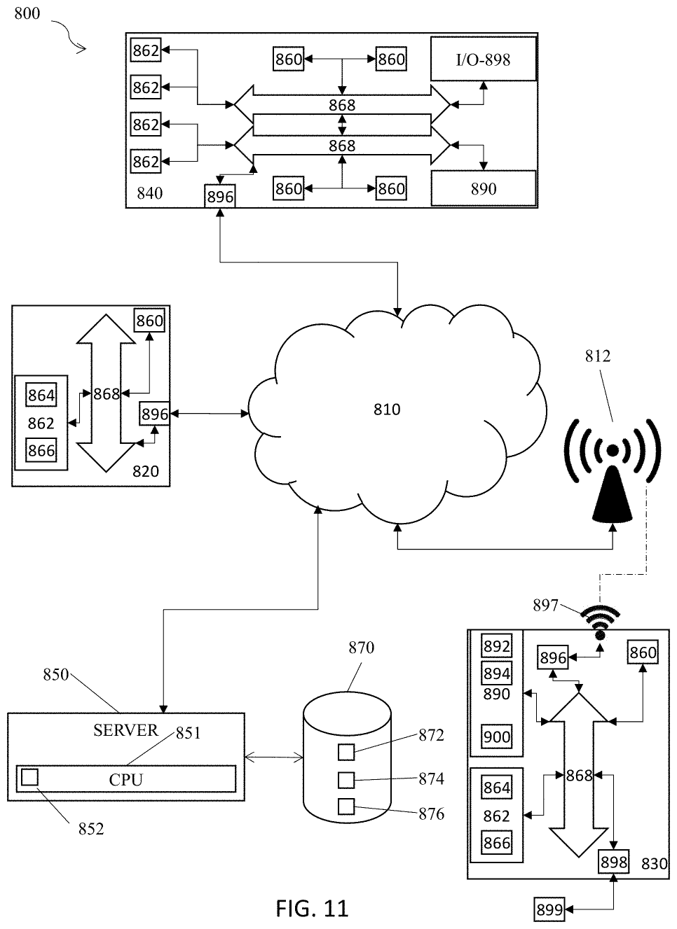

FIG. 11 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, signal generation devices (e.g., speakers), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 11, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 11, is operable to include other components that are not explicitly shown in FIG. 11, or is operable to utilize an architecture completely different than that shown in FIG. 11. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

One of ordinary skill in the art will recognize that the word “ton” has multiple meanings. In one embodiment, the word “ton” as used herein is used to refer to an imperial ton, meaning 2,240 lbs (a “long ton”). In another embodiment, the word “ton” as used herein refers to 2,000 lbs (a “short ton”). In yet another embodiment, the word “ton” refers to a metric ton, equal to 1,000 kg, or approximately 2,204 lbs. While the metric ton is often spelled “tonne,” one of ordinary skill in the art will recognize that, as used in this application, the metric ton is often shortened to “ton.” In still another embodiment, ton is used to mean 2,400 lbs (a ton longweight). It will be understood that the present invention is able to operate under any definition of the word “ton” as described above.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A system for generating and trading carbon credits, comprising:
a server, including a processor and a memory, in network communication with at least one user device;
wherein the server generates at least one user profile associated with the user device;
wherein the server receives a project creation message from the at least one user device, including information regarding at least one carbon reduction project;
wherein the server automatically verifies the existence and efficacy of the at least one carbon reduction project;
wherein the server automatically mints a number of non-fungible carbon tokens for the at least one carbon reduction project corresponding to an estimated emissions reduction as a result of the at least one carbon reduction project; and
wherein the server receives an input from at least one second user device to purchase one or more of the non-fungible carbon tokens.

2. The system of claim 1, wherein the at least one carbon reduction project includes an oil well plugging project.

3. The system of claim 1, wherein the information regarding the at least one carbon reduction project includes at least one external validation from a third-party validation source.

4. The system of claim 1, wherein the information regarding the at least one carbon reduction project includes at least one geospatial coordinate associated with the project, at least one item of documentation for the project, and/or at least one photograph verifying the existence of the project.

5. The system of claim 1, wherein the non-fungible carbon tokens are generated in accordance with the ERC-721 standard.

6. The system of claim 1, wherein the at least one user profile is associated with role concerning at least one company profile, and wherein the at least one user profile is able to edit the at least one company profile based on the role of the at least one user profile.

7. The system of claim 1, wherein each of the non-fungible carbon tokens represents a single carbon credit.

8. The system of claim 1, wherein each of the non-fungible carbon tokens is associated with an expiration date, and wherein the server automatically transfers each non-fungible token to a burn wallet after the expiration date.

9. A system for generating and trading carbon credits, comprising:
a server, including a processor and a memory, in network communication with at least one user device;
wherein the server receives a project creation message from the at least one user device, including information regarding at least one carbon reduction project;
wherein the at least one carbon reduction project includes at least one associated sensor, wherein the at least one associated sensor is configured to detect emissions associated with the at least one carbon reduction project;
wherein the server automatically mints a number of non-fungible carbon tokens for the at least one carbon reduction project corresponding to an emissions reduction detected by the at least one associated sensor; and
wherein the server receives an input from at least one second user device to purchase one or more of the non-fungible carbon tokens.

10. The system of claim 9, wherein the at least one carbon reduction project includes an oil well plugging project.

11. The system of claim 9, wherein the information regarding the at least one carbon reduction project includes at least one external validation from a third-party validation source.

12. The system of claim 9, wherein the information regarding the at least one carbon reduction project includes at least one geospatial coordinate associated with the project, at least one item of documentation for the project, and/or at least one photograph verifying the existence of the project.

13. The system of claim 9, wherein the non-fungible carbon tokens are generated in accordance with the ERC-721 standard.

14. The system of claim 9, wherein the server generates at least one user profile, wherein the at least one user profile is associated with role concerning at least one company profile, and wherein the at least one user profile is able to edit the at least one company profile based on the role of the at least one user profile.

15. The system of claim 9, wherein each of the non-fungible carbon tokens represents a single carbon credit.

16. The system of claim 9, wherein each of the non-fungible carbon tokens is associated with an expiration date, and wherein the server automatically transfers each non-fungible token to a burn wallet after the expiration date.

17. A method for generating and trading carbon credits, comprising:
providing a server, including a processor and a memory, in network communication with at least one user device;
the server generating at least one user profile associated with the user device;
the server receiving a project creation message from the at least one user device, including information regarding at least one carbon reduction project;
the server automatically verifying the existence and efficacy of the at least one carbon reduction project;
the server automatically minting a number of non-fungible carbon tokens for the at least one carbon reduction project corresponding to an estimated emissions reduction as a result of the at least one carbon reduction project; and
the server receiving an input from at least one second user device to purchase one or more of the non-fungible carbon tokens.

18. The system of claim 17, wherein the at least one carbon reduction project includes an oil well plugging project.

19. The system of claim 17, wherein the information regarding the at least one carbon reduction project includes at least one external validation from a third-party validation source.

20. The system of claim 17, wherein the information regarding the at least one carbon reduction project includes at least one geospatial coordinate associated with the project, at least one item of documentation for the project, and/or at least one photograph verifying the existence of the project.
